(19) United States
(12) Patent Application Publication
(10) Pub. No.: US 2017/0292853 A1
(43) Pub. Date: Oct. 12, 2017

(54) TAILORED VOICE NAVIGATION ANALYSIS SYSTEM

(71) Applicant: International Business Machines Corporation, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(21) Appl. No.: 15/091,959

(22) Filed: Apr. 6, 2016

(51) Int. Cl. G01C 21/36; G06F 3/16; G06F 17/30; G10L 13/08; G10L 13/033

(52) U.S. Cl. CPC G01C 21/3629; G10L 13/08; G10L 13/033; G06F 17/30772; G06F 3/165; G10L 2013/021

(57) ABSTRACT

An approach, for tailoring voice navigation instruction output. A navigation audio tailor receives songs including instrumental segments and associated vocal segments. The navigation audio tailor identifies, instrumental only segments where the instrumental only segments mark time durations based on the instrumental segments being absent of the associated vocal segments. The navigation audio tailor receives, navigations instructions where the navigation instructions are based on text to create voice navigation instructions. The navigation audio tailor determines, navigation instruction output timing where the navigation instructions output timing is associated to one of the instrumental only segments to create tailored navigation instructions and the navigation audio tailor outputs the tailored navigation instructions to an audio playback device where the output combines at least one of the songs.

### BACKGROUND OF THE INVENTION

The present invention relates generally to Global Positioning System (GPS) navigation and more particularly, to controlling/tailoring navigation instruction output to avoid competing with other voices during audio playback.

Voice navigation systems, utilizing GPS have become ubiquitous, especially when providing spoken directions to drivers in vehicles, allowing them to follow directions (e.g., “turn left in 1 mile”) while keeping their eyes on the road. In an automotive example, a driver (e.g., user) can utilize the audio playback system of the car to combine the music playback with spoken navigation directions/instructions.

Music can consist of instrumental backing tracks (e.g., instrumental) and lyrics (e.g., vocals). A song can comprise periodic portions of vocals while instrumentals continue throughout the song.

In some cases, both music and navigation instructions are output on a single audio playback device. For example, an in-car stereo can control both music and navigation output, or a mobile device can be connected to the car stereo to output both music and navigation instructions. When a navigation instruction needs to be output, an audio playback system can reduce the volume of the music so that the navigation instruction can be heard. In this case, the vocals in the “volume reduced music” can interfere with the navigation instructions being output. Simultaneous output of more than one voice can reduce voice navigation instruction comprehension while lyrical interference can contribute to an unpleasant listening experience.

### SUMMARY

As disclosed herein, a method for tailoring voice navigation instruction output, the method comprising: receiving, by navigation audio tailor, one or more songs comprising one or more instrumental segments and associated one or more vocal segments; identifying, by the navigation audio tailor, one or more instrumental only segments; receiving, by the navigation audio tailor, one or more text navigation instructions wherein the one or more text navigation instructions are used to create one or more voice navigation instructions; determining, by the navigation audio tailor, one or more output timings based on the one or more voice navigation instructions and at least one of the one or more instrumental only segments, creating one or more tailored navigation instructions and outputting, by the navigation audio tailor, the one or more tailored navigation instructions to an audio playback device to combine the one or more tailored navigation instructions with at least one of the one or more songs. A computer system and a computer program product corresponding to the above method are also disclosed herein.

### BRIEF DESCRIPTION OF THE DRAWINGS

FIG. 1 is a functional block diagram illustrating a computing environment, in accordance with an embodiment of the present invention;

FIG. 2 is a flowchart depicting tailored voice navigation analysis processing, in accordance with an embodiment of the present invention;

FIG. 3 depicts a sample audio analysis diagram for use by a tailored voice navigation analysis system, in accordance with an embodiment of the present invention; and

FIG. 4 depicts a block diagram of components of the server and/or the computing device, in accordance with an embodiment of the present invention.

### DETAILED DESCRIPTION

Embodiments of the present invention provide systems, methods, and computer program products for analyzing music on an audio playback system and voice navigation instructions to tailor output of vocal navigation instructions to avoid competing with vocal portions of a song. Further, embodiments of the present invention can select songs in a playlist that would be suitable to play for a given journey/route, based upon music that contains non-vocal portions that closely match the expected voice navigation instructions that are planned to be output for a travel route.

Embodiments of the present invention can tailor voice navigation systems audio timing to coincide with periods in the song being played where no competing voices (vocals) are present. The navigation instructions pause until there can be a sufficient space between vocals to output the navigation instruction. For example, navigation instruction can be issued with 0.8 miles until a turn (e.g., navigation maneuver) instead of 1.0 miles. The navigation instruction output delay can still provide sufficient time to for the user to respond to the navigation instruction and the voice navigation instructions can be constructed to fit within the available time while providing as much information as possible within the context of a navigation maneuver.

Some embodiments of the present invention can create and manage playlists of songs to play during planned and/or active travel routes. Construction of a playlist can be based on anticipated voice navigation instructions for a given travel route and profiled so that song lyrics/vocals can be less likely to interfere with voice navigation instructions. Playlist order can be continually/periodically analyzed to incorporate changing conditions such as, but not limited to, traffic congestion, construction detours, weather conditions, fuel stop and dining breaks.

It should be noted that embodiments of the present invention can contextually analyze voice navigation instructions for each navigation maneuver and can tailor navigation instructions to fit the profile of the song being played while still providing sufficient notice to users of impending navigation maneuvers. The embodiments can be implemented on devices such as, but not limited to, a vehicle sound system and a mobile device.

Embodiments of the present invention will now be described in detail with reference to the figures. It should be noted that references in the specification to “an exemplary embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure or characteristic is described in connection with an embodiment, it is submitted that it is within the knowledge of one skilled in the art to affect such feature, structure or characteristic in connection with other embodiments whether or not explicitly described.

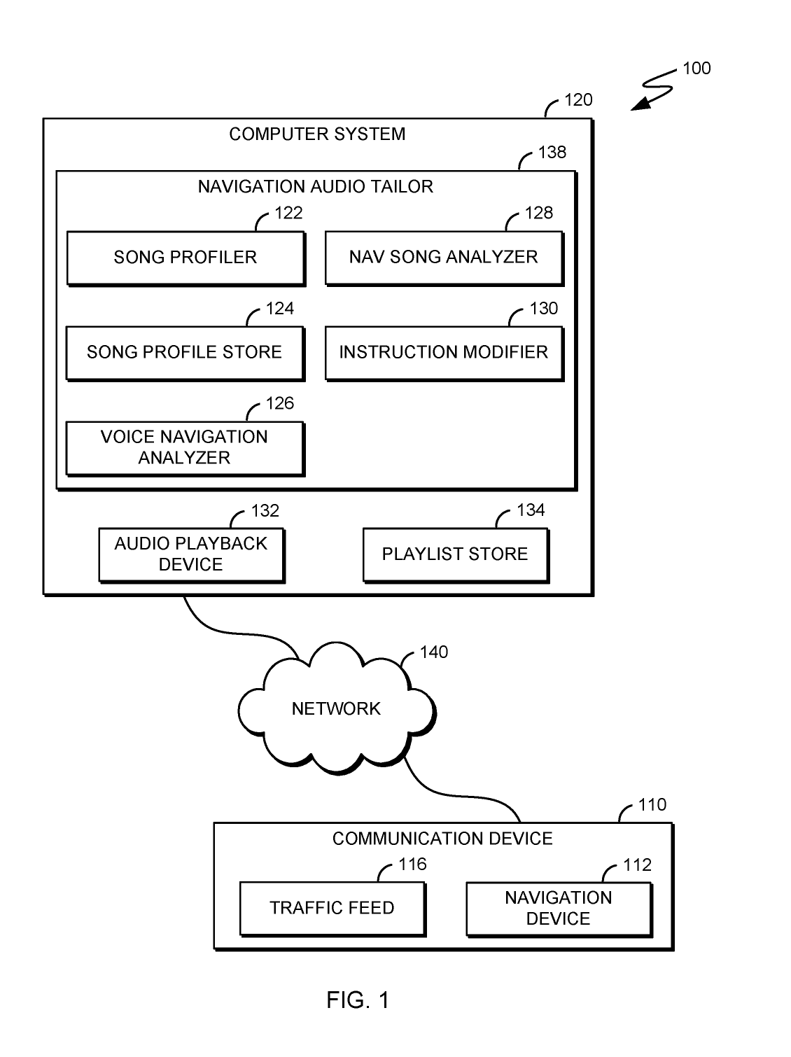

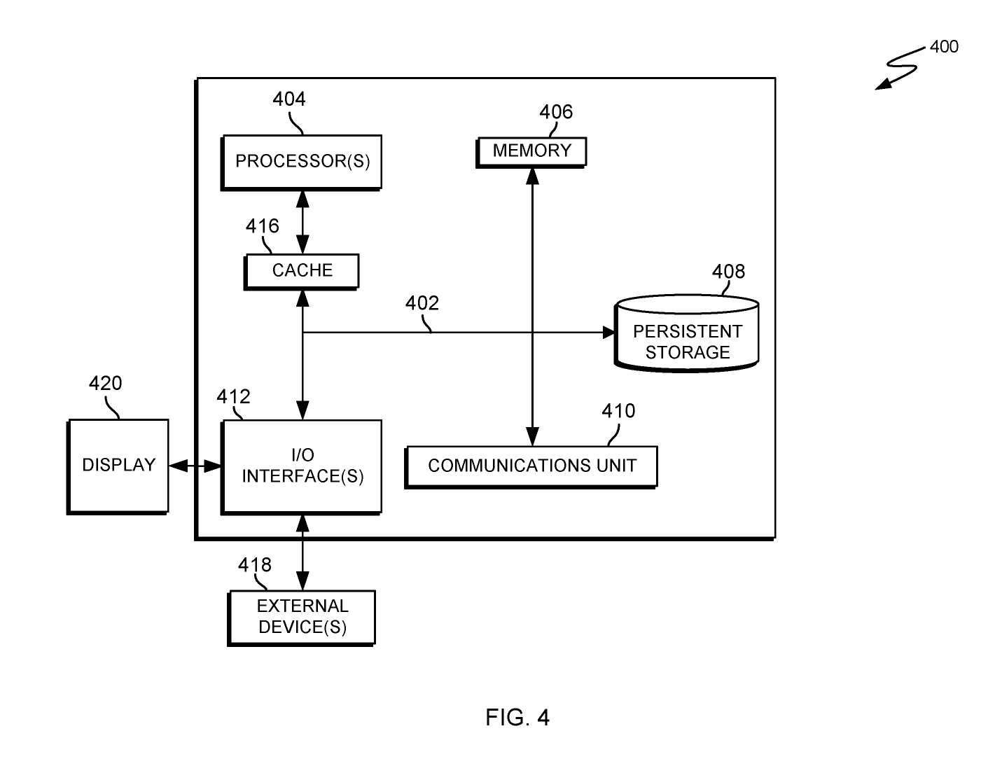

FIG. 1 is a functional block diagram of computing environment 100, in accordance with an embodiment of the present invention. Computing environment 100 comprises COMMUNICATION DEVICE 110, and COMPUTER SYSTEM 120, interconnected via NETWORK 140. COMMUNICATION DEVICE 110 and COMPUTER SYSTEM 120 can comprise desktop computers, laptop computers, specialized computer servers, or the like. In certain embodiments, COMMUNICATION DEVICE 110 and COMPUTER SYSTEM 120 represent computer systems utilizing clustered computers and components acting as a single pool of seamless resources via NETWORK 140. For example, such embodiments can be used in data center, cloud computing, storage area network (SAN), and network attached storage (NAS) applications. In general, COMMUNICATION DEVICE 110 and COMPUTER SYSTEM 120 are representative of any electronic devices, or combination of electronic devices, capable of executing computer readable program instructions, as described in detail with regard to FIG. 4.

NETWORK 140 can be, for example, a local area network (LAN), a wide area network (WAN) such as the Internet, or a combination of the two, and include wired, wireless, or fiber optic connections. In general, NETWORK 140 can be any combination of connections and protocols that will support communications between COMMUNICATION DEVICE 110 and COMPUTER SYSTEM 120, in accordance with an embodiment of the present invention.

In one embodiment of the present invention, COMMUNICATION DEVICE 110 comprises NAVIGATION DEVICE 112 and TRAFFIC FEED 116 whereas COMPUTER SYSTEM 120 comprises NAVIGATION AUDIO TAILOR 138, AUDIO PLAYBACK DEVICE 132 and PLAYLIST STORE 134. It should be noted that components of COMMUNICATION DEVICE 110 and COMPUTER SYSTEM 120 can comprise any combination of integrated or connected components that operate NAVIGATION AUDIO TAILOR 138, AUDIO PLAYBACK DEVICE 132 and/or NAVIGATION DEVICE 112. For example, embodiments of the present invention, can comprise an integrated GPS device, audio playback device and navigation instruction tailor in a single mobile device or the navigation device can be interconnected with the audio playback device where the navigation instruction tailor is separate or integrated with the navigation device and/or the audio playback system.

In one embodiment of the present invention, NAVIGATION DEVICE 112 can provide one or more travel route plans based on a user selected travel destination and a current GPS device location and/or a user selected origin. A travel route can be used to establish a list of turn-by-turn navigation instructions based on a series of navigation maneuvers that a GPS device can follow to arrive at a destination. A navigation maneuver can be defined as directional changes in path that a GPS device senses along a travel route where navigation maneuvers are affected by predetermined user settings such as, but not limited to, shortest distance, fastest travel route, points of interests, avoid freeways and avoid toll roads. Navigation instructions can be a collection of navigation instructions output to a user based on a time and/or distance threshold as a GPS device reaches a location to execute a navigation maneuver. The threshold to begin output of navigation instructions and frequency/quantity of navigation instructions to be output for each navigation maneuver can be predetermined based on default and/or user settings of NAVIGATION DEVICE 112. For example, a navigation maneuver to exit right off a freeway in two kilometers exists in NAVIGATION DEVICE 112. NAVIGATION DEVICE 112 is set to output navigation instructions at two kilometers and repeat similar navigation instructions at each 250-meter increment until the navigation maneuver event is reached. It should be noted, if the example navigation maneuver is not performed, NAVIGATION DEVICE 112 can recalculate the planned travel route and can determine a new collection of navigation maneuvers and/or associated navigation instructions based on NAVIGATION DEVICE 112 comparing current GPS position and alternative travel routes to reach the predetermined destination/location. As a journey progresses along a travel route, NAVIGATION DEVICE 112 can continuously sense a GPS device position to recalculate navigation maneuver(s) and/or navigation instructions to be output based on factors such as, but not limited to, current velocity and anticipated velocity (e.g., sharp turns, road grade, speed limit, traffic congestion). NAVIGATION DEVICE 112 can output turn-by-turn navigation instructions as text in one or more languages and/or can convert text to speech in one or more natural languages to output voice navigation instructions in one or more predetermined voices. It should be noted that NAVIGATION DEVICE 112 can be configured by a user and/or embodiments of the present invention to select preferred voices as alternatives to a default voice. Example voices such as, but not limited to, cartoon, celebrity, regional accent, varied speech pace and varied speech pitch can comprise a collection of selectable voices for output of navigation instructions. In embodiments of the present invention, NAVIGATION DEVICE 112 can send travel routes, navigation maneuvers and/or navigation instructions toward NAVIGATION AUDIO TAILOR 138.

In one embodiment of the present invention, TRAFFIC FEED 116 can comprise recent, real-time and/or live input to provide traffic related information such as, but not limited to, current road congestion, weather and traffic conditions based on social network, public, commercial traffic news, sensor and/or camera sources. In one embodiment of the present invention, TRAFFIC FEED 116 can send information toward NAVIGATION DEVICE 112 and/or NAVIGATION AUDIO TAILOR 138 as further input for determining navigation maneuver and navigations instruction timing.

In one embodiment of the present invention, AUDIO PLAYBACK DEVICE 132 can output music audio and navigation instruction audio. Music audio can comprise sources such as, but not limited to, satellite radio, portable audio player, digital audio from physical media (e.g., Compact Disc) and digital audio from networked media (e.g., cloud service). In embodiments of the present invention, AUDIO PLAYBACK DEVICE 132 can receive audio from the music audio sources, NAVIGATION DEVICE 112 and/or NAVIGATION AUDIO TAILOR 138. Further, in some embodiments of the present invention, AUDIO PLAYBACK DEVICE 132 can send music audio information toward NAVIGATION AUDIO TAILOR 138. Music audio information can comprise information such as, but not limited to, song title, artist, playback position of the current song, next song to play and music audio.

In one embodiment of the present invention, PLAYLIST STORE 134 can comprise a predetermined collection of music/song selections based on user preferences. PLAYLIST STORE 134 can sequence and send audio playback selections toward AUDIO PLAYBACK DEVICE 132. In some embodiments of the present invention, PLAYLIST STORE 134 can send playlist collections toward NAVIGATION AUDIO TAILOR 138.

In one embodiment of the present invention, NAVIGATION AUDIO TAILOR 138 comprises SONG PROFILER 122, SONG PROFILE STORE 124, VOICE NAVIGATION ANALYZER 126, NAV SONG ANALYZER 128 and INSTRUCTION MODIFIER 130.

In one embodiment of the present invention, SONG PROFILER 122 can analyze music/song content and mark the vocal timings within a given song. SONG PROFILER 122 can receive songs from music sources sent from AUDIO PLAYBACK DEVICE 132 and/or PLAYLIST STORE 134. Received songs can be analyzed by identifying vocal and instrumental tracks. When vocal and instrumental tracks are identified, vocal and/or instrumental timings can be marked by measured units such as, but not limited to, seconds, tenths of seconds and hundredths of seconds (e.g., vocals 0:23-0:29, 0:34-0:39). The vocal and/or instrumental timing marks can identify when song is absent of vocals (e.g., a voice) and those gaps can be determined to be instrumental only segments and/or voice gaps. Instrumental only segments are locations where navigation instruction can be inserted without interference of the music vocals during audio playback. Once a song is profiled with instrumental only segments and/or voice gaps timings, a profiled song can be sent toward SONG PROFILE STORE 124. It should be noted that, SONG PROFILER 122 can identify each song profile based in any format (e.g., custom and/or commercial) that allows song profile information retrieval from SONG PROFILE STORE 124 by NAV SONG ANALYZER 128.

In one embodiment of the present invention, SONG PROFILE STORE 124 comprises profiled song for use by NAVIGATION AUDIO TAILOR 138. SONG PROFILE STORE 124 can be implemented in any combination of storage methods such as, but not limited to, locally (e.g., COMPUTER SYSTEM 120) and interconnected (e.g., networked device, cloud-based). For example, an interconnected SONG PROFILE STORE 124 could be shared with a plurality of NAVIGATION AUDIO TAILOR 138 users whereas a local SONG PROFILE STORE 124 could be maintained when network connectivity is unavailable and/or not desired.

In one embodiment of the present invention, VOICE NAVIGATION ANALYZER 126 can perform real-time analysis of NAVIGATION DEVICE 112 information and can be an input/output communication point between NAVIGATION AUDIO TAILOR 138, NAVIGATION DEVICE 112, TRAFFIC FEED 116 and AUDIO PLAYBACK DEVICE 132. VOICE NAVIGATION ANALYZER 126 can receive NAVIGATION DEVICE 112 information such as, but not limited to, travel routes, navigation maneuvers and navigation instructions. Further, VOICE NAVIGATION ANALYZER 126 can receive NAVIGATION DEVICE 112 preferred voice settings, default voice settings, time to navigation maneuver, time to navigation instruction output and navigation instruction output tolerance(s). Preferred voice settings and default voice settings can be predetermined and comprise spoken word pacing (e.g., time to output a word/sentence). For example, a fast paced voice can decrease the time duration to output a sentence as compared to a slow paced voice. Some embodiments of the present invention can select alternative voices based voice pacing and best fit with instrumental only segments determined by NAV SONG ANALYZER 128. Navigation instruction output tolerance(s) can be a predetermined user setting of NAVIGATION DEVICE 112 where a series of navigation instructions are output in a predetermined interval (e.g., between 200 and 250 meters) starting near a threshold distance/time (e.g., two kilometers) of an associated navigation maneuver. In one embodiment of the present invention, VOICE NAVIGATION ANALYZER 126 can receive input from TRAFFIC FEED 116 where input can affect the timing of a navigation instruction and/or navigation maneuver (e.g., affecting the anticipated NAVIGATION DEVICE 112 velocity) based on factors such as, but not limited to, terrain, speed limit change, traffic light status and congestion. Inputs from NAVIGATION DEVICE 112 and TRAFFIC FEED 116 can be used as factors for determining timing of output of a navigation instruction by NAV SONG ANALYZER 128. VOICE NAVIGATION ANALYZER 126 can send NAVIGATION DEVICE 112 input toward NAV SONG ANALYZER 128.

Additionally, VOICE NAVIGATION ANALYZER 126 can send information such as, but not limited to, original navigation instructions, navigation instruction voice playback duration and voice selections toward NAV SONG ANALYZER 128. Based on NAV SONG ANALYZER 128 operation completion, tailored navigation instructions and output timing can be received by VOICE NAVIGATION ANALYZER 126 where VOICE NAVIGATION ANALYZER 126 can send tailored navigation instructions toward NAVIGATION DEVICE 112 based on NAV SONG ANALYZER 128 determined output timing. NAVIGATION DEVICE 112 can perform text to speech conversion of the tailored navigation instruction and can send output toward AUDIO PLAYBACK DEVICE 132. In other embodiments of the present invention, NAVIGATION AUDIO TAILOR 138 can comprise a text to speech component (not depicted) where VOICE NAVIGATION ANALYZER 126 can send tailored voice navigation instructions toward AUDIO PLAYBACK DEVICE 132.

In one embodiment of the present invention, NAV SONG ANALYZER 128 can receive input from VOICE NAVIGATION ANALYZER 126 comprising audio output timing of a navigation instruction (e.g., 23 seconds to output “upcoming turn in two miles”). NAV SONG ANALYZER 128 can receive AUDIO PLAYBACK DEVICE 132 input such as, but not limited to, the current song being played and the position of the current song (e.g., 1:34 minutes:seconds into the song). NAV SONG ANALYZER 128 can receive an associated song profile from SONG PROFILE STORE 124 to determine available instrumental only segments and/or voice gaps and can compare available instrumental only segments in the associated song profile to determine placement based on one or more navigation instruction playback durations. If an instrumental only segment is found to fit the original output timing of the navigation instruction, then original navigation instruction and output timing can be sent toward VOICE NAVIGATION ANALYZER 126 for AUDIO PLAYBACK DEVICE 132 output.

When an instrumental only segment is not found to fit a navigation instruction playback duration, then NAV SONG ANALYZER 128 can determine if the navigation instruction output timing can be moved within NAVIGATION DEVICE 112 output tolerance and/or NAVIGATION AUDIO TAILOR 138 output tolerance. If the original navigation instruction cannot be moved to fit available instrumental only segments, then NAV SONG ANALYZER 128 receives one or more of modified text navigation instructions from INSTRUCTION MODIFIER 130. NAV SONG ANALYZER 128 can select one of the received modified text navigation instructions to fit one of a range of instrumental only segments, within the predetermined output timing tolerance constraint(s), to determine a tailored navigation instruction and output timing that can be sent toward VOICE NAVIGATION ANALYZER 126 for AUDIO PLAYBACK DEVICE 132 output. The selection of the tailored navigation instruction can be a comparison of navigation instruction brevity and tolerance of timing placement to the expected output timing. It should be noted that a predetermined output tolerance can be provided in some embodiments of the present invention NAVIGATION AUDIO TAILOR 138 and can further complement NAVIGATION DEVICE 112 navigation maneuver tolerances noted in this specification. For example, given two tailored navigation instructions of one and four second output durations and given a navigation instruction output tolerance of plus/minus five seconds. If the four second navigation instruction can be output within the five second tolerance, then preference can be given toward a more verbose four second navigation instruction. If the four second navigation instruction cannot be output within the output tolerance limit, then preference can be given to brevity and the one second navigation instruction can be output. When NAV SONG ANALYZER 128 selects tailored navigation instruction and determines output timing, output can be sent toward VOICE NAVIGATION ANALYZER 126 for AUDIO PLAYBACK DEVICE 132 output.

Lastly, if a tailored navigation instruction cannot not be found to fit within any available instrumental only segments and within a predetermined output tolerance then the briefest tailored navigation instruction can be selected where navigation instruction output playback can overlap the voice proceeding the largest instrumental only segment available. When NAV SONG ANALYZER 128 selects tailored navigation instruction and determines output timing, output can be sent toward VOICE NAVIGATION ANALYZER 126 for AUDIO PLAYBACK DEVICE 132 output.

In one embodiment of the present invention, INSTRUCTION MODIFIER 130 can receive instrumental only segments available for a navigation instruction from NAV SONG ANALYZER 128. INSTRUCTION MODIFIER 130 can determine alternate navigation instructions to fit the identified instrumental only segments. INSTRUCTION MODIFIER 130 can analyze past navigation instructions output for a navigation instruction and can delete words that may be superfluous while preserving context. For example, a navigation instruction can repeat as NAVIGATION DEVICE 112 approaches a navigation maneuver. In the example, a first navigation instruction could have included a street name and the second output of a navigation instruction could increase brevity by removing the recurrent street name where the modified navigation instruction can be selected as a better fit to an available instrumental only segment by NAV SONG ANALYZER 128. Some examples of navigation instruction alternatives can comprise “In 1.2 miles take a left turn onto Broad Street”, “In 1.2 miles turn left turn onto Broad Street”, “In 1.2 miles turn left” and “turn left.” Each navigation instruction can increase in brevity and retain context by removing, moving and replacing words in the navigation instruction sentence to create a better chance of fitting an available instrumental only segments. In some embodiments of the present invention, NAV SONG ANALYZER 128 can select an alternate voice comprising faster speech pace to further reduce navigation instruction output timing while preserving navigation instruction verbosity. One or more of modified text navigation instructions can be determined and sent toward NAV SONG ANALYZER 128 for selection as a tailored navigation instruction and assignment to a best fit instrumental only segment.

In another embodiment of the present invention, NAV SONG ANALYZER 128 can analyze navigation instructions planned for a travel route and compare playlists received from PLAYLIST STORE 134 and song profiles received from SONG PROFILE STORE 124 to sort and/or create one or more playlists to fit planned navigation instructions for a planned travel route. In this embodiment of the present invention, timing of navigation instruction output can be optimized to fit song selection instrumental only segments while minimizing brevity of tailored navigation instructions. It should be noted that during travel route navigation, NAV SONG ANALYZER 128 can recalculate a planned playlist and select alternate songs based on actual travel route changes.

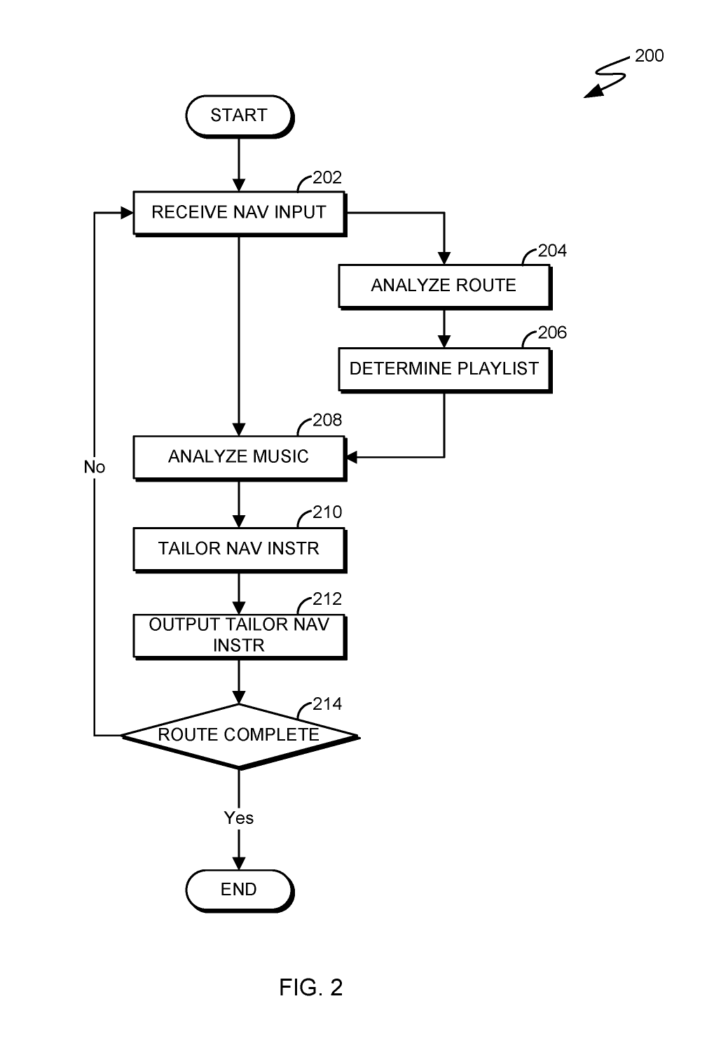

FIG. 2 is a flowchart depicting tailored voice navigation analysis processing, in accordance with an embodiment of the present invention. Operation RECEIVE NAV INPUT 202 of the tailored voice navigation analysis system flow 200, can receive input such as, but not limited to, navigation instructions, navigation instruction output timing, navigation instruction output tolerance, voice selections and voice playback timing based on approaching navigation instructions and/or planned travel routes.

In operation ANALYZE ROUTE 204, navigation instructions associated with a travel route can be analyzed to determine planned output timing of navigation instruction for one or more navigation maneuvers along a GPS travel route. Further, operation ANALYZE ROUTE 204 can comprise TRAFFIC FEED 116 information to factor real-time incident information.

In operation DETERMINE PLAYLIST 206, candidate songs can be compared to song profiles and the travel route to determine selection and playback sequence of songs comprising one or more playlist that best fit analyzed one or more received travel routes. It should be noted that priority can be given to song selection where instrumental only segments preserve unmodified navigation instruction. It should be further noted that operation DETERMINE PLAYLIST 206 can operate continuously as user interactions and/or travel route changes can affect song selection and/or song sequence of a playlist.

In operation ANALYZE MUSIC 208, music input can be received continuously and/or based on periodic navigation instruction input in operation RECEIVE NAV INPUT 202. The music input can comprise a current song being output, a queue of songs for output and/or song position in a playlist received from AUDIO PLAYBACK DEVICE 132 and/or PLAYLIST STORE 134. Operation ANALYZE MUSIC 208 can search SONG PROFILE STORE 124 for associated song profiles associated with the music input. If no song profile exists, then a song profile can be created by identifying voice and instrumental tracks of the one or more received songs to mark instrumental only segments. When a song profile is created, the song profile can be sent toward SONG PROFILE STORE 124 for usage by NAVIGATION AUDIO TAILOR 138.

During navigation operation and travel route planning, operation TAILOR NAV INSTR 210 can receive input such as, but not limited to, navigation instructions, navigation maneuvers, traffic conditions, audio/music playback selections, current audio playback position, navigation voice selection, navigation playback duration and navigation instruction output timing tolerance. Operation TAILOR NAV INSTR 210 compares instrumental only segments based on associated song profile(s) of music playback selections with one or more navigation instruction voice playback output durations to position (e.g., best fit) the navigation instruction output within available instrumental only segments. If the original navigation instruction cannot fit available instrumental only segments within an output timing tolerance, then alternate modified versions of navigation instructions can be created to improve instrumental only segment fit by increasing/decreasing navigation instruction output brevity and/or output pace while retaining navigation instruction semantics.

Operation OUTPUT TAILOR NAV INSTR 212 can send the tailored navigation instructions and/or navigation instruction output timing toward AUDIO PLAYBACK DEVICE 132 for tailored output of voice navigation instruction audio during instrumental portions of musical output.

In operation ROUTE COMPLETE 214, tailored voice navigation analysis can continue processing navigation instructions during travel route planning and/or travel route execution until a travel route is complete and/or a user discontinues operation. If a travel route is continued, then operation flows toward operation RECEIVE NAV INPUT 202, otherwise processing ends.

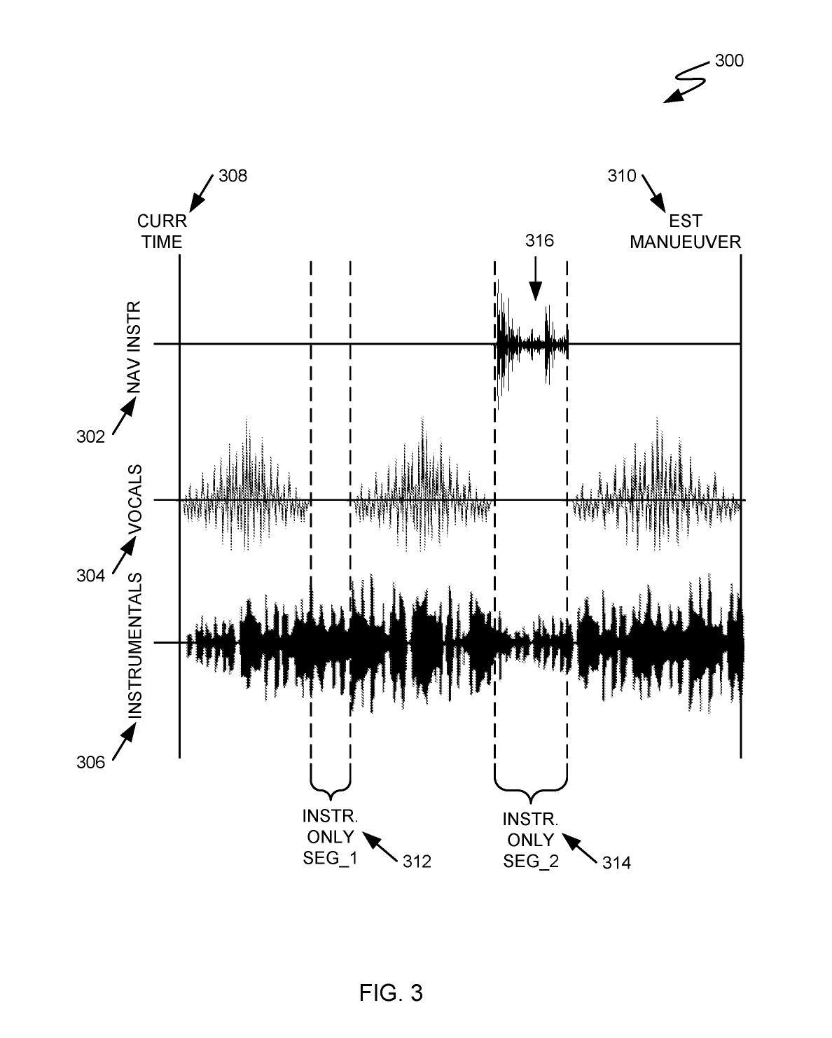

FIG. 3 depicts a sample audio analysis diagram for use by a tailored voice navigation analysis system, in accordance with an embodiment of the present invention. Tailored audio sample 300 comprises item 302 NAV INSTR, item 304 VOCALS, item 306 INSTRUMENTALS, item 308 CURR TIME, item 310 EST MANUEUVER, Item 312 INSTR. ONLY SEG_1, Item 314 INSTR. ONLY SEG_2, and item 316 NAV INSTR.

Item 302 NAV INSTR can be a navigation instruction to be output for an upcoming navigation maneuver (e.g., item 310 EST MANUEUVER). Item 302 NAV INSTR represents an original or modified audio output of a navigation instruction processed by NAVIGATION AUDIO TAILOR 138.

Item 304 VOCALS and item 306 INSTRUMENTALS represent identified vocal and instrumental audio tracks determined by NAV SONG ANALYZER 128. Identified vocal segments can be compared to an instrumental track to mark instrumental only segments (e.g., Item 312 INSTR. ONLY SEG_1 and Item 314 INSTR. ONLY SEG_2).

Item 308 CURR TIME indicates a current time NAVIGATION DEVICE 112 sends information toward NAVIGATION AUDIO TAILOR 138. Item 308 CURR TIME also represents the current song playback position received from AUDIO PLAYBACK DEVICE 132. The distance between Item 308 CURR TIME and item 310 EST MANUEUVER, estimated time of maneuver, represents the time available to output a navigation instruction. It should be noted that FIG. 3 depicts analysis of a single navigation instruction, where a more complex example could depict a series of navigation instructions as time progresses toward item 310 EST MANUEUVER.

Item 312 INSTR. ONLY SEG_1 and Item 314 INSTR. ONLY SEG_2 represent two available instrumental only segments and/or voice gaps where the instrumental only segments associated to a song can be represented in a song profile. As shown in FIG. 3, placement of item 316 NAV INSTR appears to fit best in the time slot represented by Item 314 INSTR. ONLY SEG_2 as Item 312 INSTR. ONLY SEG_1 appears narrower than item 316 NAV INSTR. In the example, item 316 NAV INSTR could be a selected alternative navigation instruction and/or an alternate voice determined by NAVIGATION AUDIO TAILOR 138 to tailor a best fit navigation instruction within a navigation output tolerance for output toward AUDIO PLAYBACK DEVICE 132.

FIG. 4 depicts a block diagram of components of COMMUNICATION DEVICE 110 and COMPUTER SYSTEM 120 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Computer system 400 includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for tailoring voice navigation instruction output, the method comprising:
receiving, by navigation audio tailor, one or more songs comprising one or more instrumental segments and associated one or more vocal segments;
identifying, by the navigation audio tailor, one or more instrumental only segments;
receiving, by the navigation audio tailor, one or more text navigation instructions wherein the one or more text navigation instructions are used to create one or more voice navigation instructions;
determining, by the navigation audio tailor, one or more output timings based on the one or more voice navigation instructions and at least one of the one or more instrumental only segments, creating one or more tailored navigation instructions; and
outputting, by the navigation audio tailor, the one or more tailored navigation instructions to an audio playback device to combine the one or more tailored navigation instructions with at least one of the one or more songs.

2. The method of claim 1, further comprising:
creating, by the navigation audio tailor, one or more modified text navigation instructions wherein the one or more modified text navigation instructions are based on at least one of removing text, moving text and replacing text associated with the one or more navigation instructions; and
replacing, by the navigation audio tailor, the one or more text navigation instructions with the one or more modified text navigation instructions.

3. The method of claim 1, further comprising:
receiving, by the navigation audio tailor, one or more traffic feed information;
determining, by the navigation audio tailor, one or more modified output timings wherein the one or more modified output timings are associated with the one or more traffic feed information, creating one or more modified tailored navigation instructions; and
replacing, by the navigation audio tailor, the one or more tailored navigation instructions with the one or more modified tailored navigation instructions.

4. The method of claim 1, further comprising:
receiving, by the navigation audio tailor, one or more planned navigation instructions wherein the one or more planned navigation instructions are based on one or more planned navigation routes;
receiving, by the navigation audio tailor, one or more playlist songs wherein the one or more playlist songs comprises the one or more songs;
determining, by the navigation audio tailor, a sequence selection of the one or more playlist songs wherein the one or more planned navigation instructions playback timings closely match the one or more instrumental only segments of the one or more playlist songs, creating a sequenced playlist collection; and
replacing, by the navigation audio tailor, the one or more songs with the sequenced playlist collection.

5. The method of claim 1, wherein identifying, by the navigation audio tailor, the one or more instrumental only segments create a song profile for each of the one or more songs.

6. The method of claim 2, wherein creating, by the navigation audio tailor, the one or more modified text navigation instructions is based on identifying at least one of recurrent words and contextual words comprising the one or more text navigation instructions associated to a navigation maneuver.

7. The method of claim 1, wherein the one or more output timings, is constrained by a predetermined output tolerance based on at least one of a time and a distance to perform a navigation maneuver.

8. A computer program product for tailoring voice navigation instruction output, the computer program product comprising:
one or more computer readable storage media and program instructions stored on the one or more computer readable storage media, the program instructions comprising:
program instructions to, receive, by navigation audio tailor, one or more songs comprising one or more instrumental segments and associated one or more vocal segments;
program instructions to, identify, by the navigation audio tailor, one or more instrumental only segments;
program instructions to, receive, by the navigation audio tailor, one or more text navigation instructions wherein the one or more text navigation instructions are used to create one or more voice navigation instructions;
program instructions to, determine, by the navigation audio tailor, one or more output timings based on the one or more voice navigation instructions and at least one of the one or more instrumental only segments, creating one or more tailored navigation instructions; and
program instructions to, output, by the navigation audio tailor, the one or more tailored navigation instructions to an audio playback device to combine the one or more tailored navigation instructions with at least one of the one or more songs.

9. The computer program product of claim 8, further comprising:
program instructions to, create, by the navigation audio tailor, one or more modified text navigation instructions wherein the one or more modified text navigation instructions are based on at least one of removing text, moving text and replacing text associated with the one or more text navigation instructions; and
program instructions to, replace, by the navigation audio tailor, the one or more text navigation instructions with the one or more modified text navigation instructions.

10. The computer program product of claim 8, further comprising:
program instructions to, receive, by the navigation audio tailor, one or more traffic feed information;
program instructions to, determine, by the navigation audio tailor, one or more modified output timings wherein the one or more modified output timings are associated with the one or more traffic feed information, creating one or more modified tailored navigation instructions; and
program instructions to, replace, by the navigation audio tailor, the one or more tailored navigation instructions with the one or more modified tailored navigation instructions.

11. The computer program product of claim 8, further comprising:
program instructions to, receive, by the navigation audio tailor, one or more planned navigation instructions wherein the one or more planned navigation instructions are based on one or more planned navigation routes;
program instructions to, receive, by the navigation audio tailor, one or more playlist songs wherein the one or more playlist songs comprises the one or more songs;
program instructions to, determine, by the navigation audio tailor, a sequence selection of the one or more playlist songs wherein the one or more planned navigation instructions playback timings closely match the one or more instrumental only segments of the one or more playlist songs, creating a sequenced playlist collection; and
program instructions to, replace, by the navigation audio tailor, the one or more songs with the sequenced playlist collection.

12. The computer program product of claim 8, wherein identify, by the navigation audio tailor, the one or more instrumental only segments create a song profile for each of the one or more songs.

13. The computer program product of claim 9, wherein create, by the navigation audio tailor, the one or more modified text navigation instructions is based on identifying at least one of recurrent words and contextual words comprising the one or more text navigation instructions associated to a navigation maneuver.

14. The computer program product of claim 8, wherein the one or more output timings, is constrained by a predetermined output tolerance based on at least one of a time and a distance to perform a navigation maneuver.

15. A computer system for tailoring voice navigation instruction output, the computer system comprising:
one or more computer processors;
one or more computer readable storage media;
program instructions stored on the one or more computer readable storage media for execution by at least one of the one or more computer processors, the program instructions comprising:
program instructions to, receive, by navigation audio tailor, one or more songs comprising one or more instrumental segments and associated one or more vocal segments;
program instructions to, identify, by the navigation audio tailor, one or more instrumental only segments;
program instructions to, receive, by the navigation audio tailor, one or more text navigation instructions wherein the one or more text navigation instructions are used to create one or more voice navigation instructions;
program instructions to, determine, by the navigation audio tailor, one or more output timings based on the one or more voice navigation instructions and at least one of the one or more instrumental only segments, creating one or more tailored navigation instructions; and
program instructions to, output, by the navigation audio tailor, the one or more tailored navigation instructions to an audio playback device to combine the one or more tailored navigation instructions with at least one of the one or more songs.

16. The computer system of claim 15, further comprising:
program instructions to, create, by the navigation audio tailor, one or more modified text navigation instructions wherein the one or more modified text navigation instructions are based on at least one of removing text, moving text and replacing text associated with the one or more text navigation instructions; and
program instructions to, replace, by the navigation audio tailor, the one or more text navigation instructions with the one or more modified text navigation instructions.

17. The computer system of claim 15, further comprising:
program instructions to, receive, by the navigation audio tailor, one or more traffic feed information;
program instructions to, determine, by the navigation audio tailor, one or more modified output timings wherein the one or more modified output timings are associated with the one or more traffic feed information, creating one or more modified tailored navigation instructions; and
program instructions to, replace, by the navigation audio tailor, the one or more tailored navigation instructions with the one or more modified tailored navigation instructions.

18. The computer system of claim 15, further comprising:
program instructions to, receive, by the navigation audio tailor, one or more planned navigation instructions wherein the one or more planned navigation instructions are based on one or more planned navigation routes;
program instructions to, receive, by the navigation audio tailor, one or more playlist songs wherein the one or more playlist songs comprises the one or more songs;
program instructions to, determine, by the navigation audio tailor, a sequence selection of the one or more playlist songs wherein the one or more planned navigation instructions playback timings closely match the one or more instrumental only segments of the one or more playlist songs, creating a sequenced playlist collection; and
program instructions to, replace, by the navigation audio tailor, the one or more songs with the sequenced playlist collection.

19. The computer system of claim 15, wherein identify, by the navigation audio tailor, the one or more instrumental only segments create a song profile for each of the one or more songs.

20. The computer system of claim 16, wherein create, by the navigation audio tailor, the one or more modified text navigation instructions is based on identifying at least one of recurrent words and contextual words comprising the one or more text navigation instructions associated to a navigation maneuver.
